(19) United States
(12) Patent Application Publication
(10) Pub. No.: US 2023/0096056 A1
(43) Pub. Date: Mar. 30, 2023

(54) High-Pressure Fuel Pump

(71) Applicant: Robert Bosch GmbH, Stuttgart (DE)

(72) Inventor: Markus Schetter, Ebersbach (DE)

(21) Appl. No.: 17/910,820

(22) PCT Filed: Feb. 1, 2021
(86) PCT No.: PCT/EP2021/052244

§ 371 Date: Sep. 11, 2022

(30) Foreign Application Priority Data
Mar. 20, 2020 (DE) 10 2020 203 652.7

(51) Int. Cl. F02M 59/44; F04B 1/0439; F04B 53/16

(52) U.S. Cl. CPC F02M 59/442; F04B 1/0439; F04B 53/164

(57) ABSTRACT

A high pressure fuel pump includes (i) a pump housing, (ii) a pump piston, (iii) a high pressure seal which is disposed between the pump piston and the pump housing and seals the pump piston with respect to a high pressure region, and (iv) an annular guide element which guides the pump piston in a sliding fit and which is disposed towards the high pressure region when seen from the high pressure seal. The annular guide element has at least one fluid connection which fluidically connects a first region to a second region. The first region is adjacent to a first end face of the guide element. And the second region is adjacent to a second end face of the guide element.

### PRIOR ART

The invention relates to a high-pressure fuel pump according to the pre-characterizing clause of claim 1.

Commercially available high-pressure fuel pumps for fuel systems of internal combustion engines are known. These high-pressure fuel pumps compress the fuel to a high pressure and supply it to a fuel rail from where the fuel is injected directly into combustion chambers of the internal combustion engine. A pump piston is guided in the pump housing and the pump piston is applied by a piston spring against a drive. It is known from DE 10 2013 226 088 Al to mount and guide the pump piston at two axially mutually spaced-apart points relative to the pump housing, inter alia for example by an annular guide element. It is moreover known from DE 10 2013 226 088 A1 to arrange a high-pressure seal, which seals off the pump piston relative to a high-pressure region, between the pump piston and the housing.

### DESCRIPTION OF THE INVENTION

The problem on which the present invention is based is solved by a high-pressure fuel pump with the features of claim 1. Advantageous developments are given in the dependent claims.

For an optimum sealing effect of the high-pressure seal, it is required that the high fluid pressure prevailing in the high-pressure region (gasoline or diesel can be considered as the fluid) is present with as little restriction as possible as far as the high-pressure seal.

This is connected with the fact that the high-pressure seal typically has one or more sealing lips, a relatively low fluid pressure existing at the region of the said sealing lips which is averted from the high pressure. In order to obtain an optimum sealing effect, the sealing lips are therefore applied by the high fluid pressure prevailing in the high pressure against the movable pump piston and/or against a housing section.

In the high-pressure fuel pump according to the invention, the fluid connection of the annular guide element ensures that the high fluid pressure is present largely unrestrictedly over the guide element as far as the high-pressure seal, and to be precise even when a guide gap between the pump piston and the annular guide element is only relatively small. By virtue of such a small guide gap, it is, however, ensured that tilting of a longitudinal axis of the pump piston relative to an ideal guide axis or center axis of the high-pressure seal is relatively small, as a result of which, on the one hand, damage to the high-pressure seal inter alia during mounting and, on the other hand, non-uniform sealing by the high-pressure seal at the pump piston and/or a housing-side section are prevented.

Specifically, this is achieved by a high-pressure fuel pump with a pump housing and a pump piston. The pump housing can, for example, be polygonal or rotationally symmetrical and is in most cases manufactured from metal. The pump piston is usually a stepped piston which, together with a section which has a larger diameter, delimits a delivery space, whereas a section which has a smaller diameter is applied by a piston spring against a drive. The drive can, for example, comprise an eccentric section or a cam section. The high-pressure fuel pump is often a so-called “plug-in pump” which is plugged into an opening in a cylinder head of an engine block and is driven by a camshaft of the internal combustion engine.

Also part of the high-pressure fuel pump is the said high-pressure seal which is arranged between the pump piston and the pump housing and seals off the pump piston relative to a high-pressure region. This high-pressure seal can also be annular and have one or more sealing lips. On the side averted from the high-pressure region, the high-pressure seal is retained, for example, by a retaining ring in the pump housing which is pressed into the pump housing and in this respect can form, for example, the abovementioned housing-side section.

Also part of the high-pressure fuel pump is the said annular guide element which guides the pump piston with a sliding fit with a small amount of guide play and which, viewed from the high-pressure seal, is arranged facing the high-pressure region and has at least one fluid connection which connects a first region adjacent to a first end face of the guide element to a second region adjacent to a second end face of the guide element. The annular guide element can be manufactured, for example, from metal, in particular from brass, and anchored in the pump housing with a press fit. According to the invention, the radial guide play between the guide element and the pump piston is as small as possible.

In a development, it is provided that the fluid connection has a groove, which runs as a whole in the axial direction of the guide element, in a lateral surface of the guide element. This is very simple technically and can be implemented inexpensively. It should be understood, however, that, alternatively or in addition to such a groove, for example a through bore can be provided which runs as a whole in the axial direction of the annular guide element.

In a development thereof, it is provided that the groove which runs as a whole in the axial direction of the guide element is arranged in a radially inner or in a radially outer lateral surface of the guide element. In the latter case, the contact surface between the guide element and the pump piston remains uninfluenced by the fluid connection and hence optimal, and in the former case the fluid path is simplified.

In a development, it is provided that the fluid connection comprises a groove, which runs in a radial direction of the guide element, in an end face of the guide element. This is based on the consideration that the annular guide element is often accommodated in a stepped opening or bore in the pump housing and in particular bears against a shoulder of the stepped opening with the end face facing the high-pressure region. The continuity of the fluid connection is ensured by the presence in this end face of a groove which runs as a whole in a radial direction.

In a development, it is provided that the annular guide element has a plurality of fluid connections. This increases the effective cross section of the fluid connection, as a result of which the high fluid pressure is conducted particularly well to the high-pressure seal.

In a development thereof, it is provided that the fluid connections are arranged so that they are uniformly distributed, viewed in a circumferential direction of the guide element. Uniform pressing is consequently ensured especially when the guide element is accommodated with a press fit in the pump housing.

The invention is explained below with reference to the attached drawings, in which:

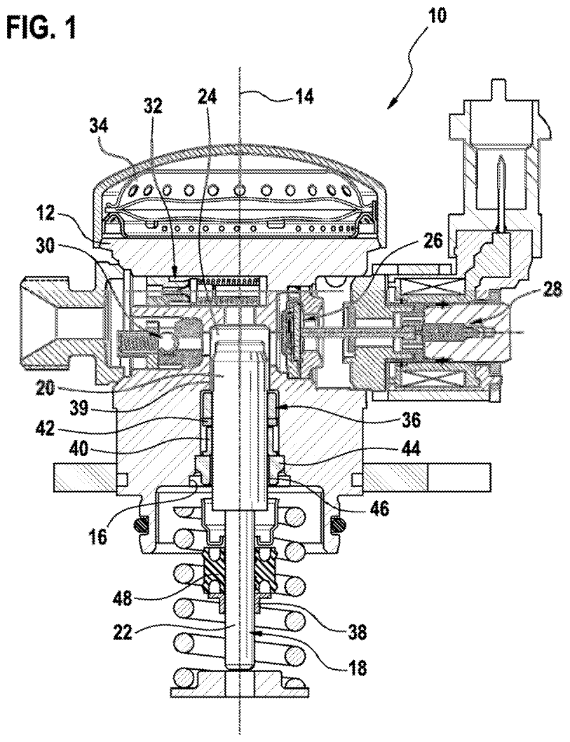

FIG. 1 shows a longitudinal section through a high-pressure fuel pump with an annular guide element;

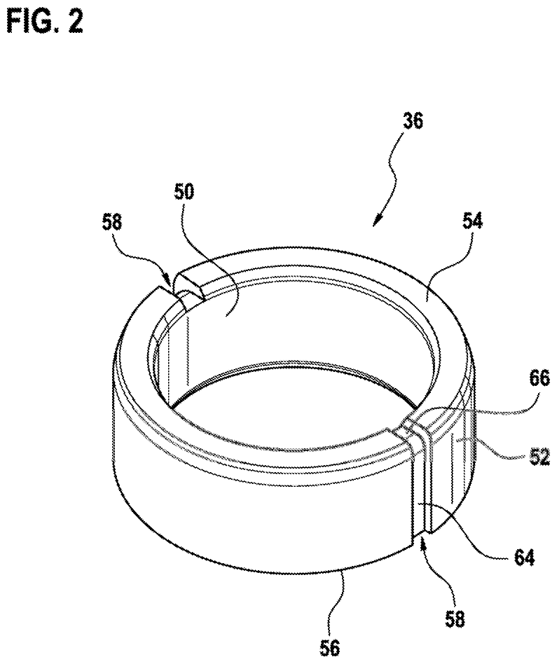

FIG. 2 shows a perspective illustration of the annular guide element in FIG. 1; and

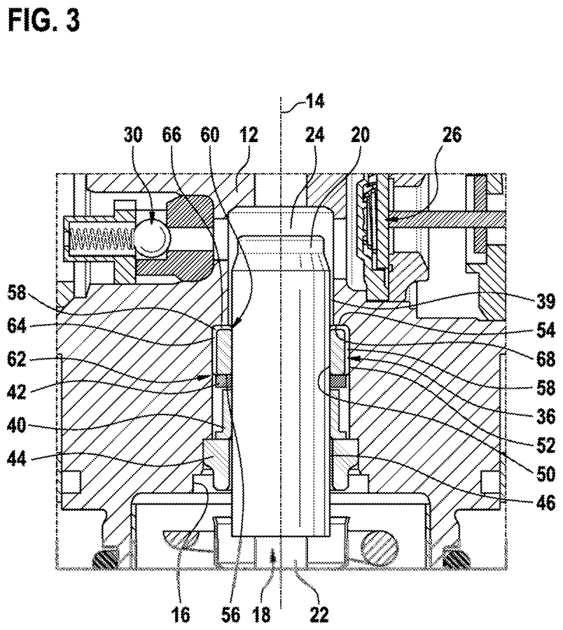

FIG. 3 shows a longitudinal section through an enlarged region of the high-pressure fuel pump in FIG. 1.

In the drawings, a high-pressure fuel pump for a fuel system of an internal combustion engine as a whole has the reference numeral 10. It comprises a pump housing 12 which in the present case has, for example, an as a whole approximately cylindrical shape with a longitudinal axis 14. A stepped opening 16 which is similar to a blind hole, is produced, for example, by a bore, and in which a pump piston 18 is accommodated, in the present case is present in the pump housing 12, for example, coaxially with respect to the longitudinal axis 14.

The pump piston 18 is designed as an elongated cylindrical part with a first section 20, viewed in the axial direction, and a second section 22. The first section 20 has a larger diameter than the second section 22. The first section 20 faces a delivery space 24, whereas the second section 22 faces a drive which is not illustrated.

Also part of the high-pressure fuel pump 10 is an inlet valve 26 which is designed as a non-return valve but which can be held by force in an open position by an electromagnetic actuating device 28. A further part of the high-pressure fuel pump 10 is an outlet valve 30, designed as a non-return valve, and a pressure relief valve 32. In FIG. 1, a membrane damper 34 for damping low-pressure pulses is moreover present in the region of an upper end face (which has no reference numeral) of the pump housing 12.

The high-pressure fuel pump 10 is part of a fuel system (not illustrated further) of an internal combustion engine. The fuel, for example gasoline or diesel, passes to the inlet valve 26 from a usually electrically driven pre-feed pump. The pump piston 18 is set in back-and-forth motion at its lower end in FIG. 1 by a drive, for example a camshaft of the internal combustion engine, as a result of which fuel is drawn via the inlet valve 26 into the delivery space 24, is compressed there to a high pressure, and finally expelled via the outlet valve 30 to a fuel rail. The fuel passes from there into associated combustion chambers via injectors.

The pump piston 18 is guided relative to the pump housing 12 at two axially spaced-apart points, namely, on the one hand, just below the delivery space 24 through a first annular guide element 36 and just above a lower end in FIG. 1 through a second annular guide element 38. The first annular guide element 36 is explained in even more detail below. A relatively more pronounced gap 39 is in contrast present between the pump piston 18 and a section, adjacent to the delivery space 24, of the opening 16.

As is clear from FIG. 3, an annular high-pressure seal 40 is arranged just below the first annular guide element 36 between the pump housing 12 and the pump piston 18. It can be manufactured, for example, from a PTFE material. An annular spring 42 is tensioned between the longitudinal axis 14 and the first annular guide element 36, viewed in the axial direction of the longitudinal axis 14. It can here, for example, be a disk spring or a helical spring. The high-pressure seal 40 is applied by the latter against a retaining ring 44, arranged in the drawings below the high-pressure seal 40, which is retained in the opening 16 of the pump housing 12 with a press fit. A relatively highly pronounced gap 46 is present between the retaining ring 44 and the section 20 of the pump piston 18. A low-pressure seal 48 is arranged in FIG. 1 above the second guide element 38.

Reference is now made to FIG. 2, in which the first guide ring 36 is illustrated in greater detail. The first guide ring 36 can be manufactured from a metal material, for example from brass. It has as a whole a straight, circular cylindrical shape with an inner lateral surface 50 which is straight and in the installed position runs parallel to the longitudinal axis 14, an outer lateral surface 52 which is straight and in the installed position runs parallel to the longitudinal axis 14, a first end face 54 which is upward in FIG. 2 and a second end face 56 which is downward in FIG. 2. The diameter of the inner lateral surface 50 is selected such that the first section 20 of the pump piston 18 is guided with a sliding fit in the first annular guide element 36 only with a relatively small amount of guide play.

The first annular guide element 36 has two fluid connections 58, situated precisely opposite each other and in this respect arranged so that they are uniformly distributed, viewed in a circumferential direction of the first guide element 36, which fluidically connect a first region 60 adjacent to the first end face 54 to a second region 62 adjacent to the second end face 56. The two fluid connections 58 are identical. Therefore only one of the two fluid connections 58 is explained in detail below.

The fluid connection 58 has a groove 64, which runs in the axial direction parallel to the longitudinal axis 14, in the outer lateral surface 52 of the first guide element 36. The groove here has an as a whole approximately rectangular cross-section although other cross-sections are in principle also conceivable. In an embodiment which is not illustrated, the groove could also run obliquely relative to the longitudinal axis 14. In a further embodiment which is not illustrated, the groove could also be present in the inner lateral surface. The fluid connection 58 moreover has a groove 66, which runs in a radial direction (orthogonally to the longitudinal axis 14), in the first end face 54, the upper one in the drawings. In an embodiment which is not illustrated, this groove could also be arranged obliquely, i.e. have a directional component facing in the circumferential direction. The groove 66 which runs radially opens into the groove 64 which runs axially, as a result of which a continuous fluid connection 58 is created.

In the installed position shown in FIGS. 1 and 3, the upper first end face 54 of the first annular guide element 36 bears against a shoulder 68 of the stepped opening 16. The first annular guide element 36 is moreover accommodated with a press fit with its outer lateral surface 52 in the opening 16 and is retained therein. The very high fluid pressure prevailing during a compression stroke of the pump piston 18 in the delivery space 24 which in this respect is part of a high-pressure region is transmitted from the delivery space 24 via the gap 39 to the first region 60 situated above the first annular guide element 36 and from there, via the grooves 66 which run radially and the grooves 64 which run axially of the two fluid connections 58, into the second region 62 situated in FIGS. 1 and 3 below the first annular guide element 36.

In this way, the said high fluid pressure is also present on the radial outer side of the high-pressure seal 40, as a result of which the latter is pressed, on the one hand, radially inward against the pump piston 18 and, on the other hand, axially downward against the retaining ring 44. The high-pressure seal 40 can thus ensure good sealing of the high fluid pressure relative to the region situated below the high-pressure seal 40 in FIGS. 1 and 3. At the same time, the pump piston 18 is guided with virtually no play through the first annular guide element 36 by virtue of the small guide gap such that it cannot tilt, or at least not significantly, relative to the longitudinal axis 14.

1. A high-pressure fuel pump, comprising:
a pump housing;
a pump piston;
a high-pressure seal arranged between the pump piston and the pump housing and configured to seal off the pump piston relative to a high-pressure region; and
an annular guide element configured to guide the pump piston with a sliding fit, said annular guide element being arranged facing the high-pressure region, viewed from the high-pressure seal,
wherein the annular guide element has at least one fluid connection which is configured to fluidically connect a first region adjacent to a first end face of the guide element to a second region adjacent to a second end face of the guide element.

2. The high-pressure fuel pump as claimed in claim 1, wherein the fluid connection comprises a groove which runs as a whole in the axial direction of the guide element in a lateral surface of the guide element.

3. The high-pressure fuel pump as claimed in claim 2, wherein the groove which runs as a whole in the axial direction of the guide element is arranged in a radially inner or a radially outer lateral surface.

4. The high-pressure fuel pump as claimed in claim 1, wherein the fluid connection comprises a groove which runs as a whole in a radial direction of the guide element in an end face of the guide element.

5. The high-pressure fuel pump as claimed in claim 1, wherein the annular guide element has a plurality of fluid connections.

6. The high-pressure fuel pump as claimed in claim 5, wherein the plurality of fluid connections are arranged so that they are uniformly distributed, viewed in a circumferential direction of the guide element.
